(19) United States
(12) Patent Application Publication
(10) Pub. No.: US 2013/0031130 A1
(43) Pub. Date: Jan. 31, 2013

(54) SYSTEM AND METHOD FOR INTERACTIVE QUERYING AND ANALYSIS OF DATA

(71) Applicant: Charles Wilbur Hahm, Encinitas, CA (US)

(72) Inventor: Charles Wilbur Hahm, Encinitas, CA (US)

(21) Appl. No.: 13/340,656

(22) Filed: Dec. 29, 2011

Related U.S. Application Data
(60) Provisional application No. 61/428,321, filed on Dec. 30, 2010.

(51) Int. Cl. G06F 17/30

(52) U.S. Cl. 707/769; 707/E17.014

(57) ABSTRACT

This invention provides a system and method for the querying and analysis of data that is displayed on a computer monitor with the aid of a computer. More specifically, the invention provides interactive queries that enable a user to discover and quantify statistical relationships more efficiently and with greater granularity than is possible with current systems. The invention also provides methods and systems to perform data query via a computer display in a manner that accelerates the process of quantitative analysis.

### CROSS-REFERENCE TO RELATED APPLICATIONS

This application claims the benefit of PPA 61/428,321, filed Dec. 30, 2010 by the present inventor, which is incorporated here by reference.

### SUPPORT

No funding assistance has been received for this invention.

### FIELD OF THE INVENTION

The field of this invention relates to the interactive visualization, querying and statistical modeling of data.

### BACKGROUND OF THE INVENTION

Electronic systems generate vast amounts of data. This data comes from a wide range of sources, including but not limited to: transactions from point-of-sale terminals, financial transactions, casino slot machines, RFID devices and sensors that perform measurements on physical quantities such as temperature and pressure. This data may be used to develop statistical models that guide actions intended to increase profitability or minimize risk. As data volumes increase, there is a growing need to enhance the efficiency and accuracy with which data is analyzed.

Traditional approaches of data analysis involves a series of steps in which an analyst proposes and tests hypotheses against data. Data is retrieved from a data repository, undergoes exploratory analysis and is then exposed to an array of data mining tools and statistical tests. Frequently, the analyst is searching for relationships that are not readily observable or easily manipulated with existing tools and methods. These relationships may include, but not limited to patterns, correlations and anomalies. The ability to identify these relationships depends on the degree of granular access to data that the system provides to the analyst. Current systems that are limited by their course level of granularity that they offer to the analyst.

Often the object of analysis of analysis is to determine the cause of economically significant, but rarely occurring events, such as mechanical component failure or rapid fluctuation in the price of a financial instrument. These events may be difficult to observe with traditional methods because they are fleeting or abrupt and their presence is obscured by established methods of displaying data, such as bar charts or pie charts.

Current systems of querying and analyzing data are limited by a trade-off between granularity and size of data undergoing analysis. As data volumes continue to increase, analysts are faced with the challenge of sifting through large volumes of data in order to identify isolated, albeit economically significant events.

### SUMMARY OF INVENTION

### Object of Invention

In broad terms, the object of the present invention is to provide a visual interface for the rapid querying and statistical analysis of data. A related objective of the present invention is to provide the means to efficiently view, query and correlate large volumes of data on a granular level.

In broad terms, in one form the present invention comprises a system for interactive querying and quantitative analysis of data on a computer display. Data is visually represented on a computer display as a plurality of queryable pixel-matrices comprising color-coded pixel-elements. Queryable pixel-matrices may be interconnected in order to interactively query for relationships that exist within the data. The present invention also provides for statistical analysis and data manipulation via visual representation of the data that are displayed as query-able pixel-matrices.

A first aspect of the invention is a system and method for representing data as color-mapped pixel-tiles matrices on a computer display. Pixel-tile matrices may comprise a visualization of one or a plurality of data elements. Pixel tile matrix elements may also represent a plurality of data elements using the methods of interpolation, decimation or a combination thereof. This aspect of the invention provides for the maximum density of data to be visualized on a computer display. This aspect of the invention also provides for data to be displayed with greater granularity compared with other methods.

Another aspect of the invention is the querying of data by the interactive arrangement of pixel-tiles matrices on the graphical display. This aspect of the invention provides for immediate recognition of statistical relationships such as patterns, correlations and anomalies within the data. This aspect of the invention provides for the spatial localization of visual representations of data elements in response to user queries. Spatially localization of data elements evokes the innate ability of the human visual system to rapidly identify patterns and differences in visual images.

Yet another aspect of the invention is interactive control of the computer display attributes of the pixel-tile matrices in order to visually querying and select data. Display attributes include, but are not limited to, transparency and RGB color-map look-up tables. This aspect of the invention enables the analyst to interactively select data elements that are of greater interest to the user.

Yet another aspect of the invention is the linked arrangement and interactive behavior of a plurality of pixel-tile matrices on the computer display. Queries posed on one pixel-tile matrix affect the arrangement on other pixel-tile matrices. This aspect of the invention aids in the discovery of interrelationships, correlations and dependencies between components of statistical model.

Yet another aspect of the invention is the interactive labeling of data examples via the query-able pixel matrices. Labeling, as defined in the field of data-mining and statistics, is the process of assigning data examples to statistical groups. This aspect of the invention supports statistical group comparison testing such as hypothesis testing and other tests for differences between statistical groups.

Yet another aspect of the present invention is the interactive linking of queryable pixel matrices with spatial renderings of data, including geographical maps and maps of commercial enterprises such as retail floors, showrooms and casinos and other areas in which there is foot-traffic.

Yet another aspect of the present invention is the interactive linking of queryable pixel matrices with other forms of data visualization such as link maps, link-graphs heat-maps, stock tickers and tree-maps, spectrograms, bubble charts, edge maps, motion bubble charts.

Yet another aspect of the present invention is the interactive linking of queryable pixel matrices with standard statistical charts such as line graphs, scatter-plots and histograms. By interactive linking the queryable pixel matrices with statistical charts it is possible to rapidly identify patterns of events that occur within user specific bounds. For example, an analyst may be interested in identifying patterns of rare events that are statistically occur on the tails of a statistical distribution.

Yet another aspect of the invention is the ability to perform predictive analytics and statistical analysis directly on query-able pixel matrices. This aspect of the invention accelerates the iterative process of analytic discovery by providing immediate visual feedback on the performance of the analytic model.

### BRIEF DESCRIPTION OF THE FIGURES

FIG. 1 is a block diagram of the preferred embodiment of the present invention.

FIG. 2 is a block diagram of the organization of data.

FIG. 3 is a block diagram of a computing system

FIG. 4 is an operational flowchart of the high level operation of the preferred embodiment

FIG. 5a is a screen-shot of the graphical interface of the preferred embodiment.

FIG. 5b is a close-up of queryable pixel matrices.

FIG. 6a is a screen-shot of the graphical user interface of the invention in developer's design mode.

FIG. 6b is a diagram showing the relationship of the software object hierarchy of the present invention.

FIG. 7 is an operational flowchart of data transformation for the preferred embodiment.

FIG. 8a is a block diagram of a queryable pixel matrix.

FIG. 8b is a block diagram that shows an example Pixel Matrix Object and it's connectivity to graphical plot objects.

FIG. 9 is an operational flowchart of an interactive visual query of a queryable pixel matrix.

FIG. 10 is a screen shot of the graphical interface for the tagging of elements and events

FIG. 11 is a close-up screen shot of the menu of the front panel interface of the preferred embodiment.

FIG. 12 is screen shot of an SQL-style query as implemented in the preferred embodiment.

FIG. 13 is screen shot showing a query result using multiple queryable pixel matrices.

FIG. 14 is a screen shot showing the operation of interactive visual filtering queries.

FIG. 15 is a screen-shot showing the results of a visual query in which the display attributes are interactively adjusted.

FIG. 16 is a screenshot and operational flowchart of a predictive modeling example using the present invention.

### DETAILED DESCRIPTION OF THE INVENTION

Before the present methods, tools and system are described, it is to be understood that this invention is not limited to particular data sets, manipulations, tools or steps described, as such may, vary. It is also understood that the terminology described herein is for the purpose of describing particular embodiments only and is not intended to be limiting.

In one preferred embodiment, the present invention may be applied to the analysis and modeling of customer behavior. In broad terms, the objective of customer behavioral modeling and analytics is to optimize the profitability of targeted marketing efforts. These efforts often involve inducements such as promotional offers, discounts and offers of complimentary items. To optimize the profitability of these initiatives, merchants employ predictive modeling to rank customers according to anticipated profitability. These models may use nearly any type of data, but data from prior customer interactions is considered to be especially useful in predicting future behavior. Potential sources of behavioral data include: purchase transaction history, response to prior promotions and log files that record interactions from the internet.

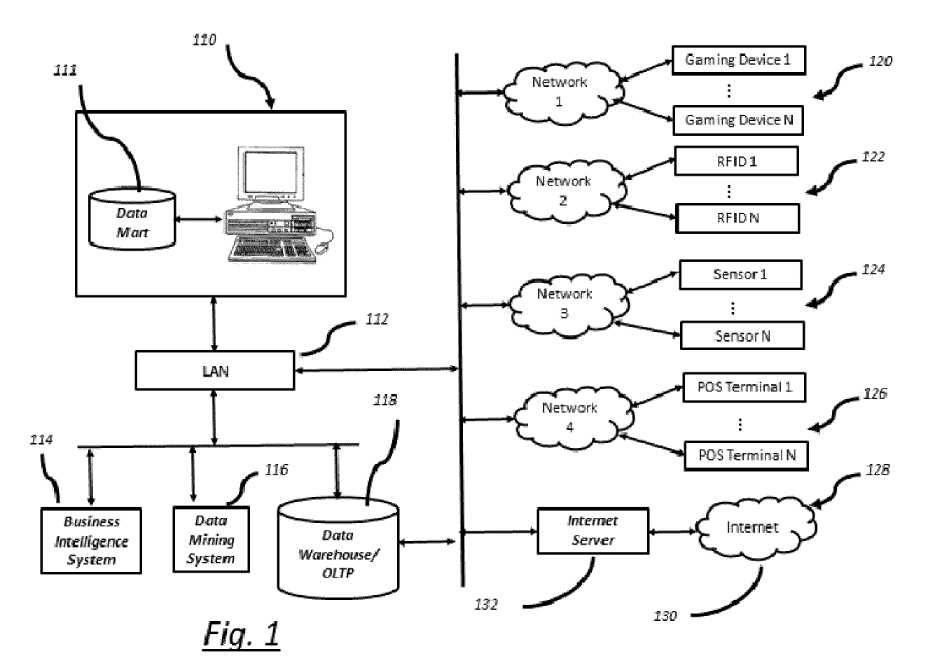

FIG. 1 is a block diagram of the preferred embodiment as applied to the analysis of customer behavior. As will be appreciated, the block diagram of FIG. 1 may also be applied to a plurality of embodiments of the present invention. FIG. 1 shows an analysis computer 110 that is connected to a LAN 112 or local computer communications network. The LAN 112 may be connected to the internet or other networks that communicate with data collection devices 120, 122, 124, 126, 128. These data collection devices include but are not limited to: networked Gaming Devices 120 such as slot machines or video lottery terminal, RFID 122 sensors, Point-of-Sale Terminals 126. Also connected to the networks may be remote sensor devices 124 that perform measurement on physical quantities such as temperature, pressure, electrical current or voltage. Also connected to the LAN is a data warehouse or data repository 118, a Data-Mining System 116 and a Business Intelligence System 114. The LAN 112 may be connected to an internet server 132 that supports customer interaction via the internet 130.

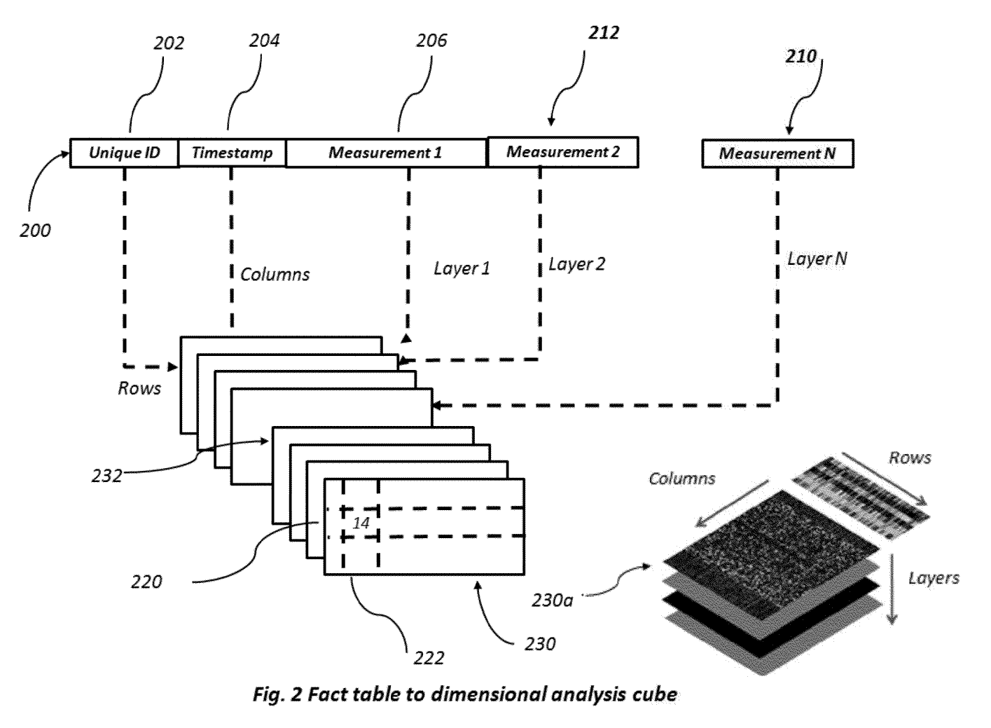

Data collection devices 120, 122, 124, 126 and 128 capture data that may be associated with customer interactions or events. Referring to FIG. 2, it is common practice to format data from customer interactions as ‘facts’ or ‘records’ 200. Facts may include a plurality of data values or measurements 206. Example measurements may include: purchase amount, casino win amount and product return amount. Also associated with each customer interaction event is a timestamp 204 indicating when the interaction occurred. For example, point-of-sale terminal 126 records a customer interaction event such as a product purchase. Other customer interaction events may include but are not limited to: a product return, a casino gaming device 120 handle pull, or a casino gaming device 120 win. Customer loyalty cards may be inserted into a gaming device 120 in order to associate customer interaction events with unique customer identifiers 202. Facts may be organized into fact tables and then stored in a data repository or data warehouse 118.

In order to facilitate statistical analysis, it is common practice to reformat the data from fact table format into a data structure that is organized according to the dimensions that are relevant to the analysis 230a. For example, histories of customer behavior may be organized into columns 222 and rows 220. In this example, the columns may be aligned to fixed time periods such as days or minutes as indicated by the Timestamp 204 field. The rows may be assigned to customers having a Unique ID 200. Measurements may be organized into layers 232 contained a single data type that corresponds to Measurement fields 206, 212, 210 within in the data fact 200. For example, one data layer may be total customer transactions and another layer may be number of returned items.

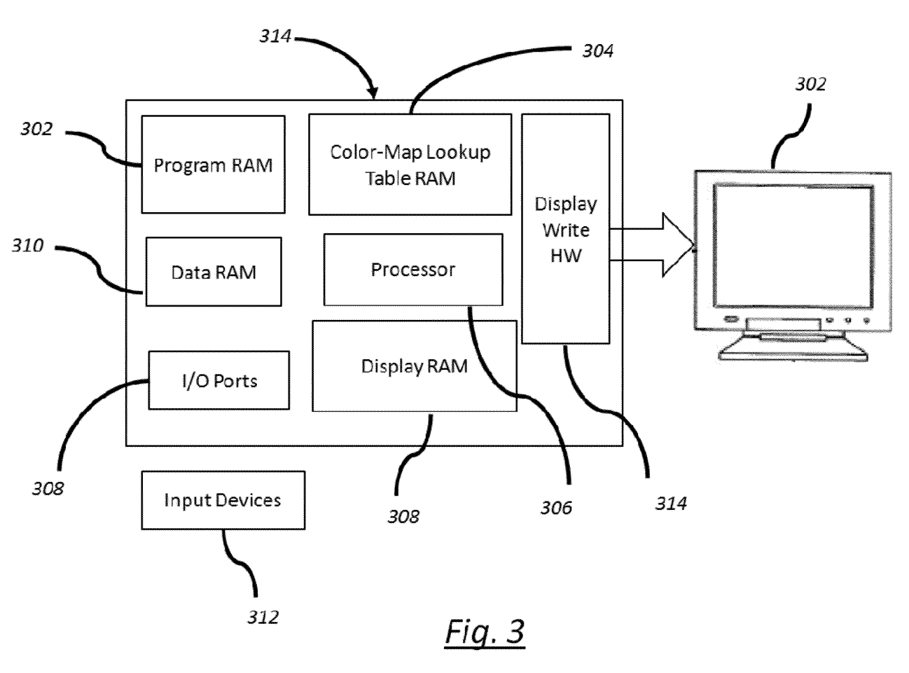

FIG. 3 is a computing device such as a personal computer, a mobile communications device or a mobile computing system 314. It comprises a computer-readable medium encoded with a computer program including a computer display 302 that may be a display terminal, a CRT or a flat panel LCD or a display on a personal communications or computing device. The computing system also contains a Processor 306, a data RAM 304, a Program RAM 302 with computer display RAM with a Color-Map Lookup Table 304 and Display Write Hardware 314.

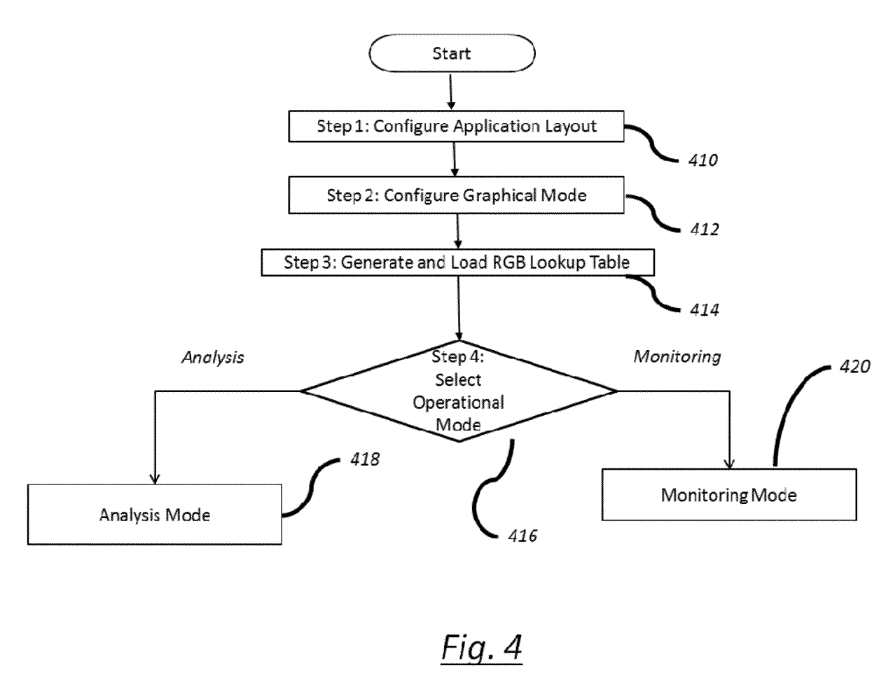

FIG. 4 is a flow diagram that shows the steps involved in configuring the present invention for the preferred embodiment. Each step is described in the following sections. The steps include Configure Application Layout, 410 Configure Graphical Display 412, Generate and load RGB Lookup Table 414, Select Operational Mode 416, Analysis Mode 418 and Monitoring Mode 420.

### Step 1: Configure Application Layout (Representative Configuration)

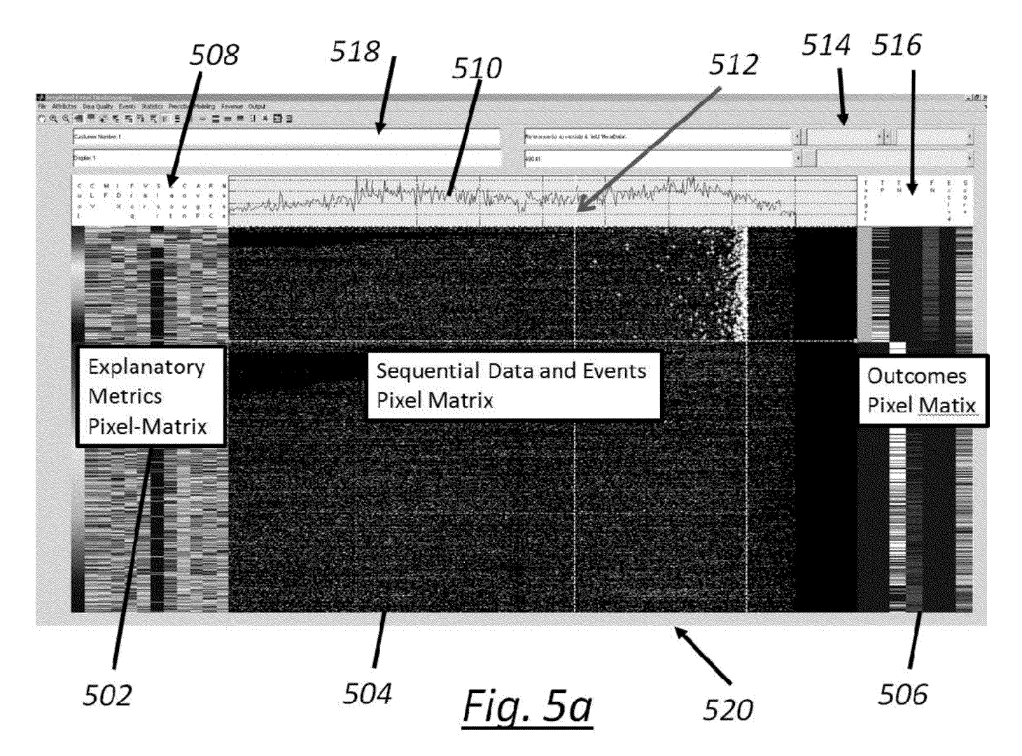

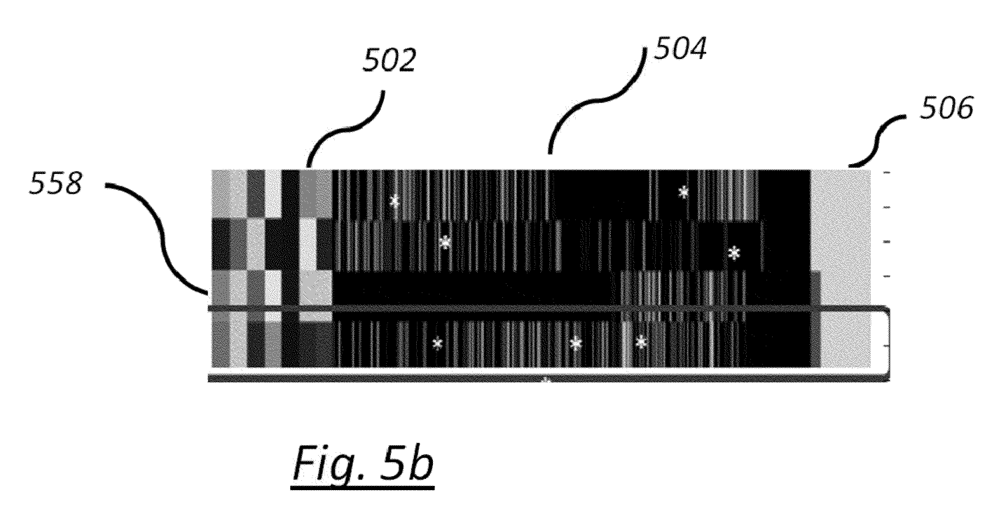

FIG. 5 is a screen-shot of the graphical display of a preferred embodiment. The layout comprises a plurality of query-able pixel-matrices. These query-able pixel-matrices include: Explanatory Metrics Pixel-Matrix 502, Sequential Data and Events Pixel-Matrix 504 and Outcomes Pixel-Matrix 506. FIG. 5b is a close-up of four rows of a selected pixel-matrix region. In this embodiment, each row contains a color-coded sequence of data values or measurements. Unique events are shown as asterisks that are overlaid on each sequence. The role and operation of events (uniquely tagged elements) is discussed in later sections. 558 is a selected row that spans the pixel matrix objects: Explanatory Metrics, 502 Sequences and Events and Outcomes 504 and Outcomes 506. The following table summarizes possible data definitions of pixel-matrices in the representative embodiment.

TABLE 1
Explanatory Metrics, Sequential Data and Events and Outcomes

| Pixel-Matrix | Characteristics and Definition | Examples |
|---|---|---|
| Explanatory | Variables that are constant or slowly changing, such | Customer demographic, age, date |
| Metrics/Variables | as demographics. | of last purchase, predictive |
| | Summary estimates from sequential data, such as | coefficient, decision metric, |
| | averages or variance | average cost of purchase, variance |
| | Variables that represent candidate hypothesis or | of purchases |
| | metrics. | |
| | Control group assignment for uplift modeling. | |
| | Treated versus Untreated customers | |
| Sequential Data | Temporally changing variables. | Purchase event, data |
| and Events | Events (discussed in later sections) | transformations of purchases, |
| | Predictive metrics that change with time. | complaint type, gaming device win |
| | Decision-rule scores or likelihood estimates. | |
| Outcomes | Predicted versus actual outcomes of classifiers: true | Known versus predicted values: |
| | positive, true negative, false positive and false | true positive, true negative, false |
| | negative. | positive, false negative. |
| | Uplift modeling: treated versus untreated | Continuous summation of rows |
| | Continuous: regression | |
| | Binary: classifier output | |
| | Predictive modeling training labels. | |

FIG. 5a also includes: a line graph 510 of the marginal summation of columns in the Sequential Data and Events Pixel-Matrix 504. Text-based definitions of columns in pixel matrices 508 and 516, mouse cursor view lines 512, text fields 518 for the display of text-based status messages run-time errors, exceptions and execution progress. Also shown in 518 may be text based query drill-down results. In other preferred embodiments, the figure may contain any number of queryable pixel image matrices. Queryable pixel matrices may be linked to other graphical components as described in other sections.

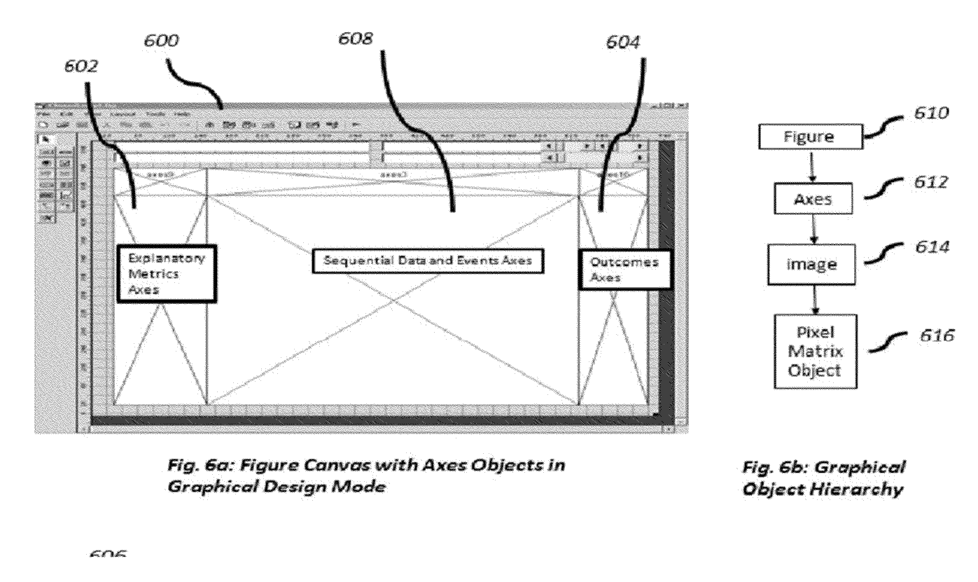

FIG. 6a is a screen-shot of the graphical layout of the preferred embodiment. The layout is in ‘development’ or ‘design’ mode in a graphical user interface development platform. The terminology of graphical interface development differs slightly, but is essentially similar across object-oriented platforms such as MS C++, C#, Java Netbeans and Java Eclipse. In design mode, containers for graphical objects are arranged on a canvas or figure. Other graphical objects include: text boxes, list-boxes and image axes or bitmaps. Graphical objects are associated with software entities by assigning ‘properties’ to the graphical objects. For example, in this embodiment, the Explanatory Metrics Axes Container 602 is associated with the graphical object for the Explanatory Metrics Pixel-Matrix 502. The Sequential Data and Events Axes Container 604 is associated with the graphical display object for Sequential Data and Events Axes 504 and the Outcomes Axes 606 Object is associated with the graphical object container for the Outcomes Pixel Matrix 506. In alternative embodiments, the graphical layout may be configured during run-time in systems that support the interactive rearrangement of graphical objects during runtime.

FIG. 6b shows the hierarchical relationship of software graphical objects that are relevant to the present invention. The roles of graphical objects and other software objects is commonly understood by those familiar in the art of modern software programming methods that emphasize object-oriented approaches to software design. On the uppermost level is the Figure object. The Figure object contains the child objects that are instantiated in the graphical user interface, such as text boxes and axes. The Axes object serves as a container for bitmap image objects. In this embodiment, the Pixel Matrix Object is a child of an image object.

### Step 2: Configure Graphical Mode (412)

This step involves the configuration, of graphical display 306 modes and color-map lookup tables 304 that may be used to display pixel-matrix objects. In a preferred embodiment, the graphical display is configured for indexed color-mapping. In indexed color-mapping, pixel elements are stored as indices to a table of RGB color values. Indexed color-mapping is familiar to those of ordinary skill in the field of graphical interface design, but is reviewed here for the benefit of the reader. In indexed color-mapping mode, data for display is stored in Data RAM 214 as indices to a color-map table 212. The color-map lookup table may be stored as an N-by-3 table of RGB intensity values, where ‘N’ corresponds to the number of colors in the lookup table. Computer display hardware 306 performs table lookups that reference the RGB color values that are displayed on the graphics terminal. A color-map lookup table with 128 RGB color entries may be indexed by a uint 8 data type.

### Step 3: Generate and Load Color-map Lookup Table (414)

Referring to FIG. 3, the Color-Map Lookup Table RAM 304 is stored in writable memory can therefore be loaded with user-customized color lookup tables. Color lookup tables may be selected from a wide range of preconfigured color-maps or palettes. Palettes have names such as ‘jet’, ‘winter’ or ‘summer’ that are suggestive of the selected color ranges. Palettes may be selected for expressiveness, operator color sensitivity or relevance to the problem being analyzed. In a preferred embodiment, a heat-map color-scheme is used, where lower data values are mapped to ‘cool’ colors such as blue and large values are hotter colors such as red and orange. Color-map lookup tables may be loaded into RAM using a single command. The following command generates a color-map theme ‘jet’ into a temporary color-map table having 128 entries.

ColorMapLUT=colormap(jet(128)); generate 128 entry lookup

The color-map lookup table may be customized before it is written the Color-Map LookUpTable 304. Customizations of the palette may be useful for the distinctive display of data exceptions such as ZERO, NULL, INFINITE, MAX. Configurable display of data exceptions is available via the Data Quality 1106 drop down menu. In one embodiment, the first index in the color-map lookup table is overwritten with the RGB value for black: [(0,0,0)]. This modified entry overwrites the original entry of blue in the ‘jet’ color-map. In other preferred embodiments, exceptional data values may be mapped interactively using the graphical user interface during runtime. The following lines of code show how the first entry in the ‘jet’ color table is replaced with the color black. The second line of code is the transfer of the modified table to the ColorMap Lookup Table 304 in hardware

ColorMapLUT(0)=[0 0 0]; % replace first entry with black

colormap(ColorMapLUT); % write modified LUT into display hardware

### Step 4: Select Operational Mode (416)

In a preferred embodiment, the present invention may operate in one of several operational modes. Operational modes differ according to how data is loaded and updated. In analysis mode 418, the present invention is used for retrospective analysis such as data-mining and decision rule development. In analysis mode 418, the user queries a data warehouse or data repository 118. The retrieved data is assembled into a local data mart 111 that contains data that is relevant to the problem being analyzed. In Monitoring Mode 420, the present invention may monitor and query streaming data in real-time, as it is sampled by data collection devices 120, 122, 124, 126, 128. Monitoring mode, for example, is the preferred mode for stock trader who is interested in querying financial market activity in real-time.

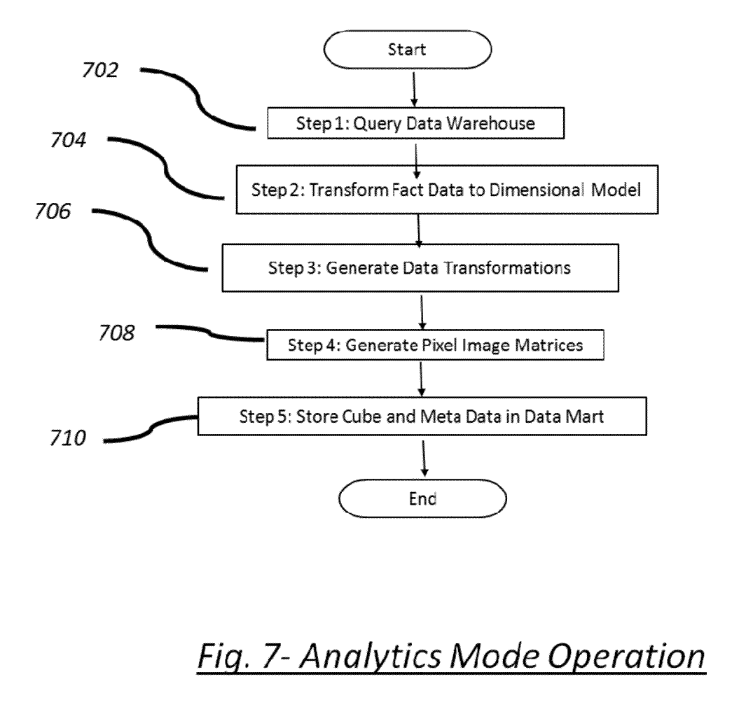

FIG. 7 is a flowchart of Analytics Mode Operation 418. It depicts the steps involved in retrieving data from a data warehouse and its transformation into a Data Mart 111. Data from the local Data Mart 111 can be loaded and manipulated by the present invention. Referring to FIG. 7, the following paragraphs outline each of the steps involved in this process. The data transformation process results in visual representations of data including queryable pixel matrices that are displayed on the computer display 302.

### Analysis Operational Mode, Step 1: Query Data Warehouse (702)

Referring to FIG. 7, data may be retrieved from a data warehouse 118 using a standard database query language such as ASM-SQL. The data returned from the query as a sequence of facts 200 or fact table.

### Analysis Operational Mode, Step 2: Remap Data to Dimensional Analysis Cube (704)

In this step, data is transformed from fact table format into a dimensional model. This process is known to those of ordinary skill in the fields of database engineering. In a preferred embodiment, the dimensional model is formatted for time-series analysis. Time-series formatted data is useful for: survival and hazard modeling, failure analysis, stochastic process. Referring to FIG. 2, rows 220 in the dimensional analysis cube contain measurements that are associated with a unique identifier 202. Columns 222 may correspond to a regularly-spaced time-intervals or sampling periods. Each data measurement field 204, 206, 210 is mapped to a layer to the dimensional analysis cube 230. The process of mapping data from a fact 224 table to a dimensional analysis cube involves the translation of data from measurement fields 206, 208, 210 to appropriate positions within a dimensional analysis cube 230. 230a shows the orientation of the data dimensions as applied to the preferred embodiment.

### Analysis Operational Mode, Step 3: Generate Data Transformations (706)

Referring to FIGS. 2 and 7, measurements may be transformed into features or variables that are useful in statistical modeling. Each variable corresponds to a layer in a dimensional analysis cube 230. Data transformations may involve any of a wide range of mathematical operations such as cross-products, ratios, resealing, binning. The use of data transformations is well-known to those of ordinary skill in the field of statistical pattern recognition and classification. In a preferred embodiment, Explanatory Metrics 502 use feature variables that are transformations of data in the Sequential Data and Events field 504. Examples include the average of the sequence, the variance, or the maximum.

### Data Mining Mode, Step 4: Generate Pixel Image Matrices (708)

In this step, data in the dimensional analysis cube 230 is coded into Pixel Images Matrices 708. As discussed in other sections, Pixel Image matrices may contain indices into the Colormap Lookup table. In this embodiment, color mapping is optimized to provide maximum visual contrast of the displayed data. One efficient method for accomplishing this is known as equal-frequency binning, whereby an equal number of data elements are mapped to each color-bin. This method is an efficient implementation of histogram equalization. These coding methods may be applied to both continuous and discrete data values. As described in later sections, color-mappings are interactively adjusted during visual filtering queries.

### Data Mining Mode Step 5: Store Data Structures and Meta Data in Data Mart 710

The Pixel Image Matrices and associated meta-data structures are stored in the Data Mart. Once these are stored they may be analyzed and the results rendered on a computer display 302. The data transformation process results in visual representations of data including queryable pixel matrices that are displayed on the computer display 302.

### Components of an Interactive Pixel Matrix Object

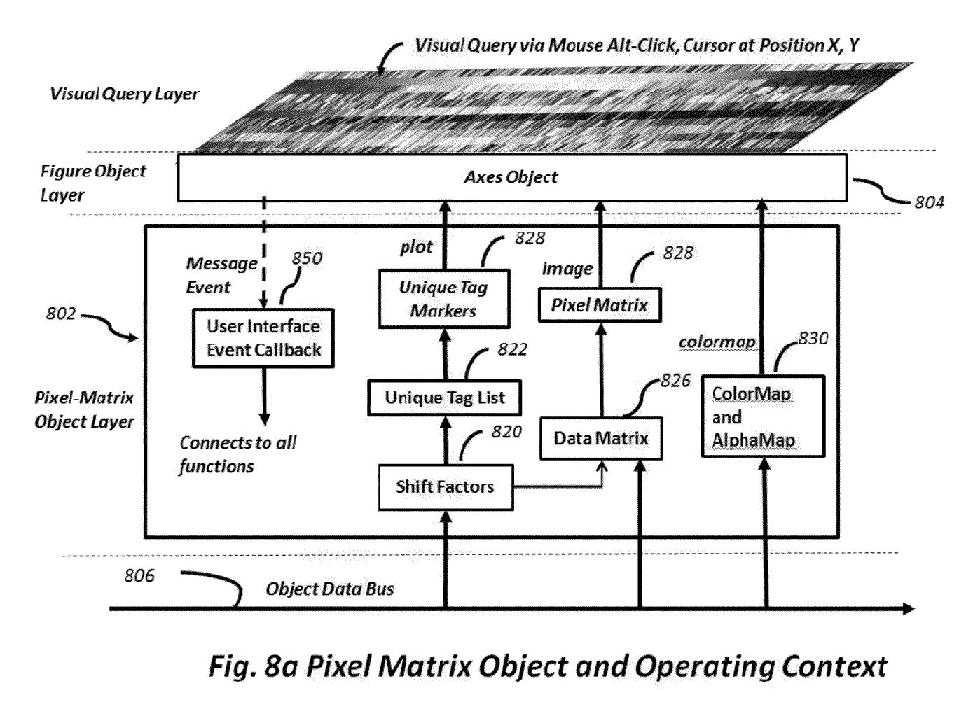

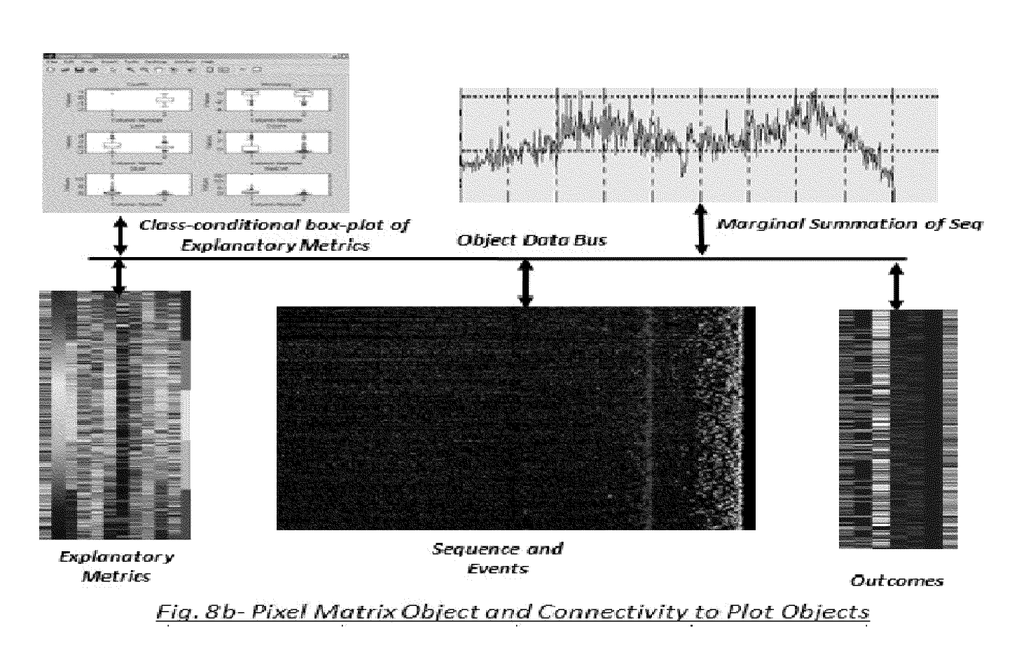

FIG. 8 is a block diagram of a query-able pixel-matrix object 802 and operating context. This diagram is divided into layers that are consistent with the Graphical Object Hierarchy shown in FIG. 6b. The Visual Query Layer comprises the computer display 302 and input devices such as mouse and keyboard 312. The Figure Object Layer comprises a plurality of Axes Objects 804 that are instantiated on a Figure Canvas 600. An Axes Object 804 may be a container for a Pixel Matrix Object 802. The Object Data Bus 806 is the software communication connection between Pixel Matrix Objects 802 and other connected software components.

Referring to FIG. 8, the following discussion describes the elements contained within the Pixel Matrix Object 802. The User Interface Event Callback 850 is the event handler that is invoked when a screen event message is received. This event handler controls the functions within the Pixel Matrix Object 802. The Shift Factors 820 control the positioning of the data elements in the Unique Tag List 822, Data Matrix 826 and Pixel Matrix 828. The Unique Tag List 822 is a list of distinct data element. The ColorMap and AlphaMap 830 are image attributes that control the appearance of the data rendered on the visual display. The Data Matrix 826 contains the data elements that are being analyzed. The Unique Tag Markers 828 contain the marker attributes of the Unique Tag List 828.

FIG. 8a shows instantiations of the Pixel Matrix Objects on the Visual Interface. The data bus shows the connectivity between these objects and conventional box-plot and line graph plots. Queries on the pixel matrix objects invoke updates of all plot-objects with dependent data.

### Example Operation of an Interactive Pixel Matrix Object

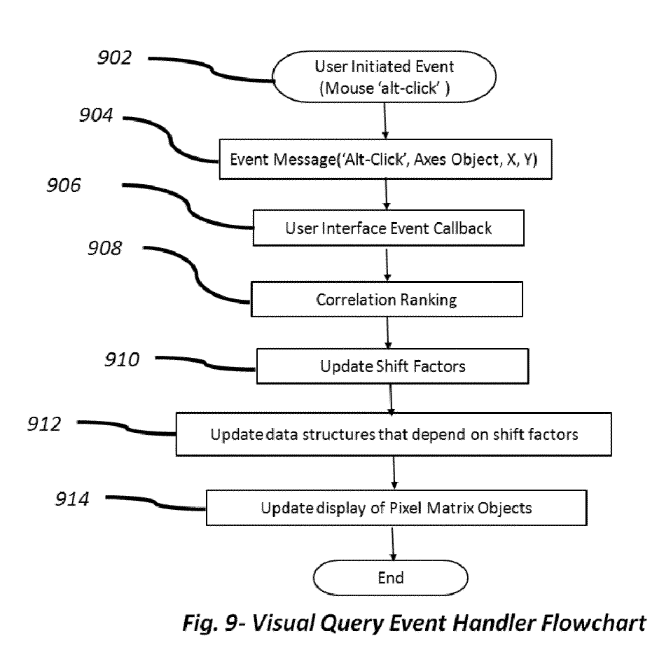

FIG. 9 is a flowchart of the actions that are taken when an example visual query is invoked. A visual query may be initiated when a user performs an action such as a Mouse ‘Alt-Click’ 902. This action generates an Event Message 904 that is dispatched by the operating system to the User Interface Event Callback 850. The event message contains a number of data fields including the X and Y position of the mouse cursor within the Axes Object 804. In this example, the User Interface Event Callback interprets a mouse ‘alt-click’ event as a request for a visual correlation query. As detailed in the Visual Query section, this type of query works by grouping the visual representation of queried data elements. The queried data elements are returned as an ordered list of data elements from a Correlation Ranking 908 function. The ordered list is used to update the Pixel Matrix Object Shift Factors 910. The update also invokes a re-ordering of data structures that depend on the Shift Factors 912, including: the Unique Tag List 822, and the Pixel Matrix 828 and Data Matrix 826. Lastly, the visual display is updated 914 to reflect the newly ordered state of Pixel Matrix Objects.

### Unique Tag Elements

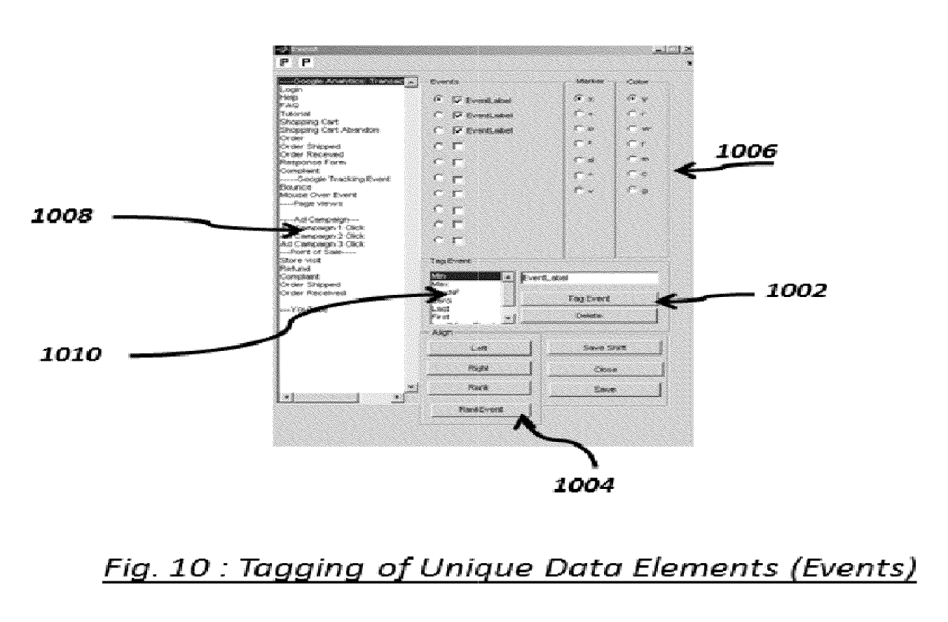

Referring to FIG. 10, the present invention supports the tagging of individual data elements. In time-series analysis, tagged elements may indicate uniquely occurring events. For example, the final purchase in a sequence of customer transactions may be tagged as an event that indicates the onset of attrition. Tagged Events may serve as positional reference markers or anchors that direct the adjustment of Shift Factors 850. Tagged elements may also be used to distinguish classes or statistical subgroups. For example, a sub-population of customers that are tagged by a purchase event may be defined as ‘responders’ in marketing campaign analysis. These responders may be analyzed as a distinct statistical subgroup using aspects of the present invention. FIG. 10 is a screen-shot of the graphical interface that provides for the tagging and management of events. Text labels for events are user-defined using the text box and buttons in Event Tagging 1002. Selection criteria (such as maximum or last in a sequence) for events may be selected using the list-box 1010. Event marker assignment (such as color and shape) are selectable using 1006.

### Drop Down Menu Operation

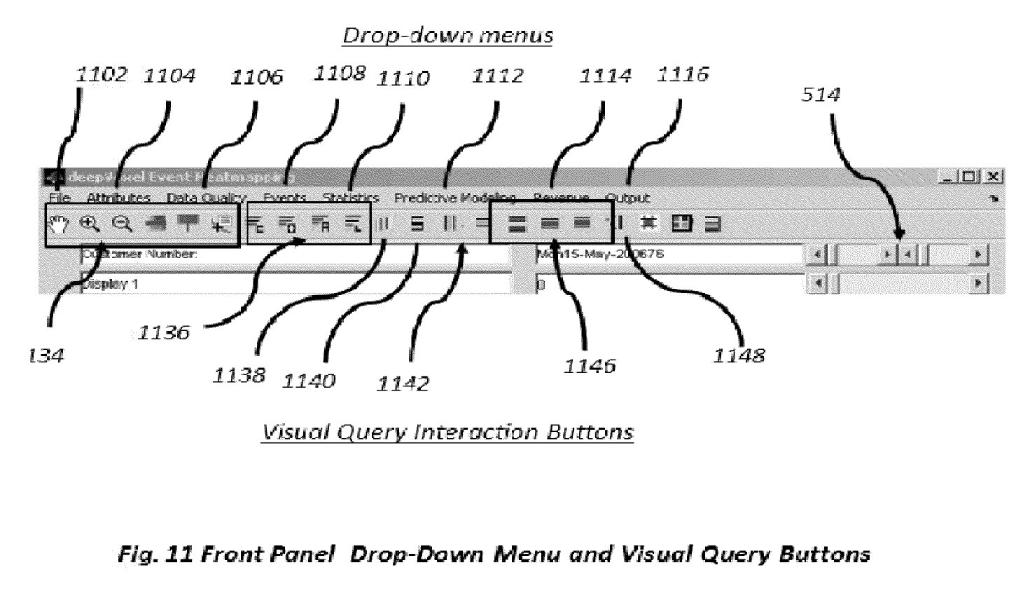

FIG. 11 is a close-up of the main front panel, highlighting the drop-down menus and various data interactions that are unique to the present invention. The File drop-down menu 1102 controls the loading of data. Attributes 1104 controls the loading of the Explanatory Metrics. Data Quality 1106 controls the selective display of exception data values such as NULL, INF, MAX, ZERO. Data Quality operation is useful in root cause analysis to identify the source of data quality problems. Events 1108 is a drop down for the Unique Elements Menu. Statistics 1110 provides for the analysis of group statistics via the visual interface. Predictive Modeling 1112 provides for the export of data to data-mining engines and also provides for selected classification and regression algorithms such as logistic regression. Revenue 1114 computes the predicted economic value of predictive analysis scenarios. Output 1116 controls the display of the Outcomes Pixel Matrix Object.

### Visual Data Interactions

The lower half of FIG. 11 shows front panel buttons that provide for a plurality of data interactions. Panning, zooming and data drill are provided in 1134. Correlation Queries may be access via the buttons in the box highlighted by 1136. Single-click Layer Navigation 1138 provides for single-click loading of sequential data layers in a dimensional cube. Summation 1140 is a query that provides for the calculation of summed values over highlighted regions of the data display. Region selection is performed by 1142. These work in concert with cursor controls. 1146 provides for the assignment of class labels to data sequences. Visual filtering queries are provided by the slider adjustments 514. Examples and the functional operation of these buttons are described in the sections that follow.

### A Usage Example 1

### Visual Query

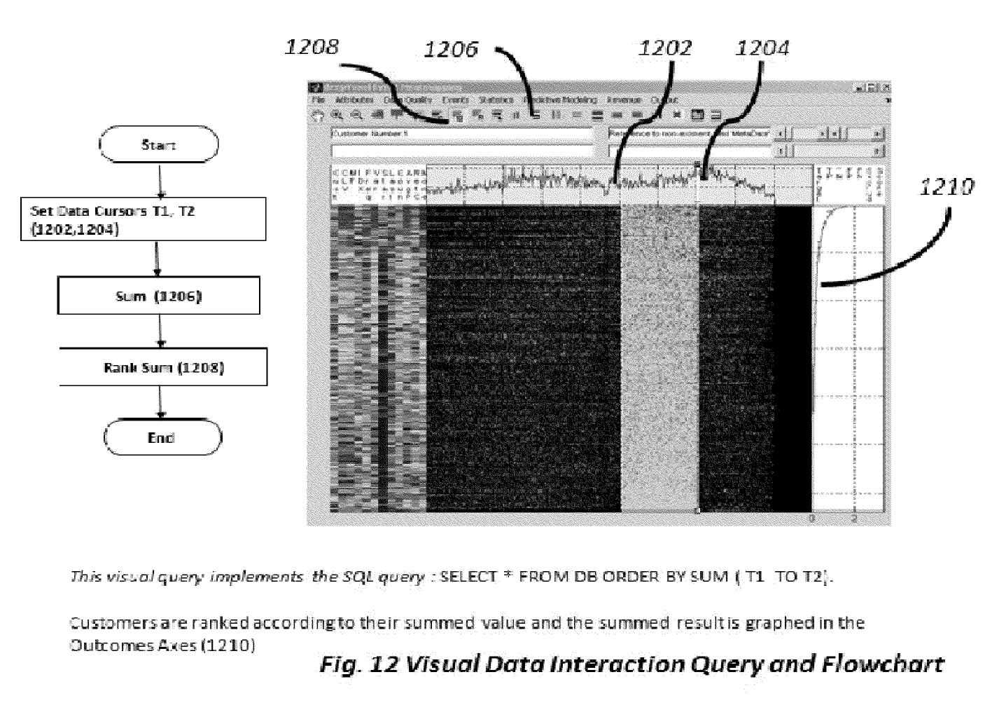

FIG. 12 shows the steps involved in performing a basic visual query. This visual query implements and SQL SELECT command that ranks customers according to the summed value of transactions from t=T1 to T2. The steps taken to perform the query are described in the flowchart in the figure: Set data cursors 1202 and 1204 to the data columns T1 and T2, Sum 1206 and Rank 1208.

### Visual Correlation Queries and Linked Pixel Matrix Objects

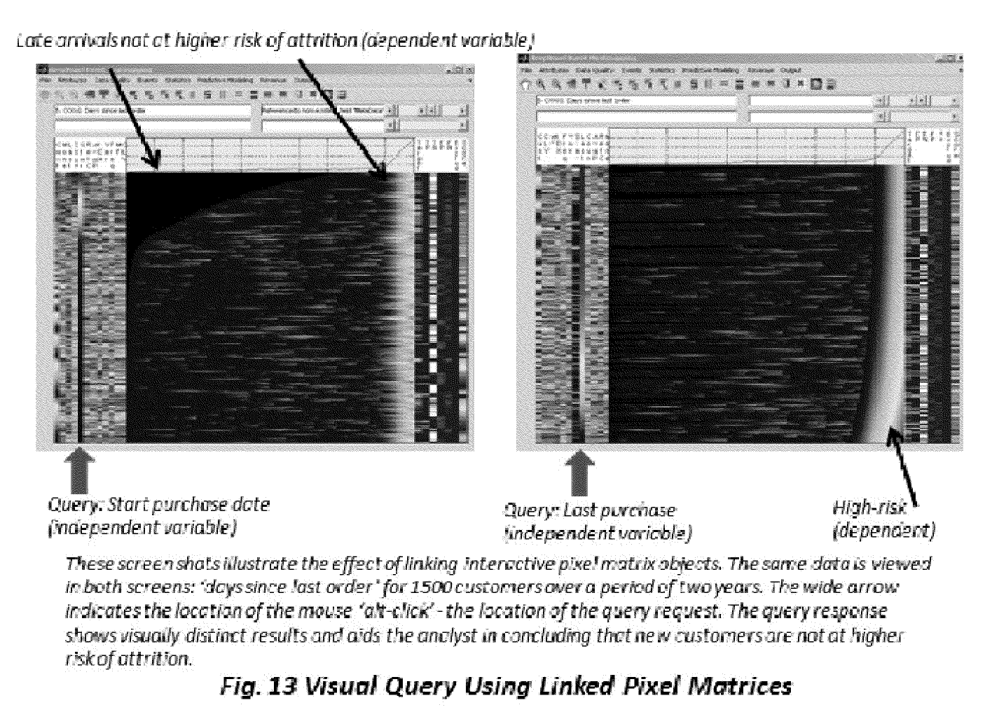

Broadly speaking, visual queries are manipulations of data performed via interactions with the pixel matrix object. Correlation queries work by spatially localizing data on a computer display. Spatial localization enables the analyst to quickly detect patterns. FIG. 13 shows screen shots that illustrate the effect of linking interactive pixel matrix objects. The same data is viewed in both screens: ‘days since last order’ for 1500 customers over a period of two years. The wide arrow indicates the location of the mouse ‘alt-click’—the location of the query request. The query response shows visually distinct results and aids the analyst in concluding that new customers are not at higher risk of attrition Visual queries rely on the unique properties of the Pixel Object Matrix. As will be appreciated, multiple pixel matrix objects may be linked and combined in order to produce novel queries that extend beyond the examples given in this disclosure.

FIG. 13 also illustrates the visual query mechanism as it relates to dependent and independent variables. This visual query works by imposing a correlation on a queried data sequence. The queried data sequence then plays the role of the independent/response variable. As described in prior sections, the linkage mechanisms across the pixel matrix objects invoke a reordering of visual representations of the data. The visual appearances of the pixel matrix objects reveal aspects of the relationship between the queried or independent and response or dependent data. Aspects of these appearances include visual smoothness, consistency, continuity, order. Each of these visual aspects possesses a statistical correlate: entropy, correlation and variance, for example.

### Usage Example 2

### Visual Data Filtering

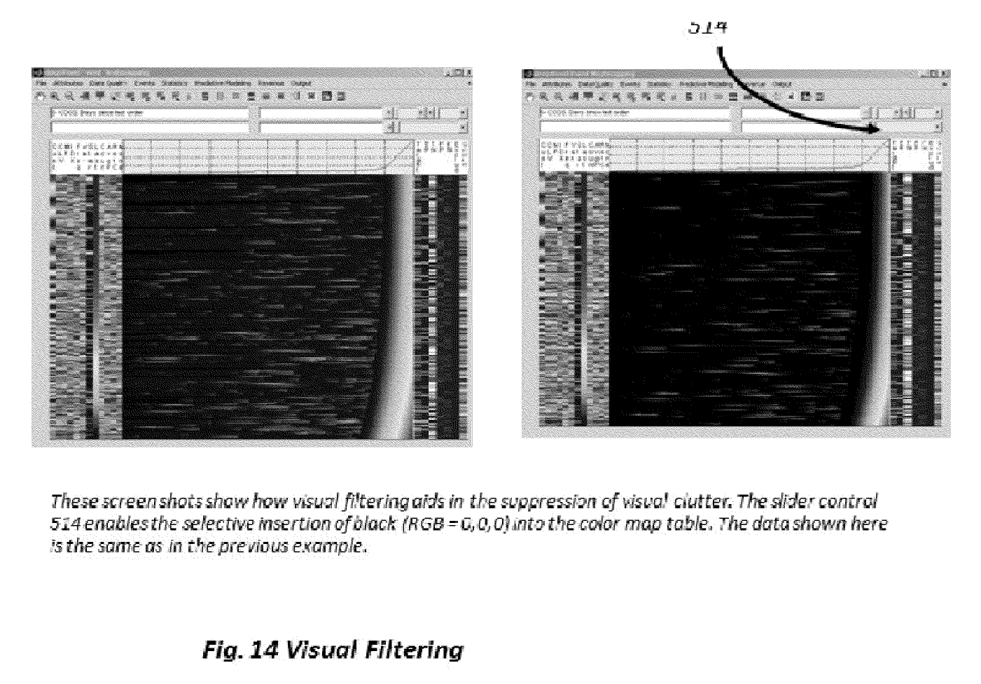

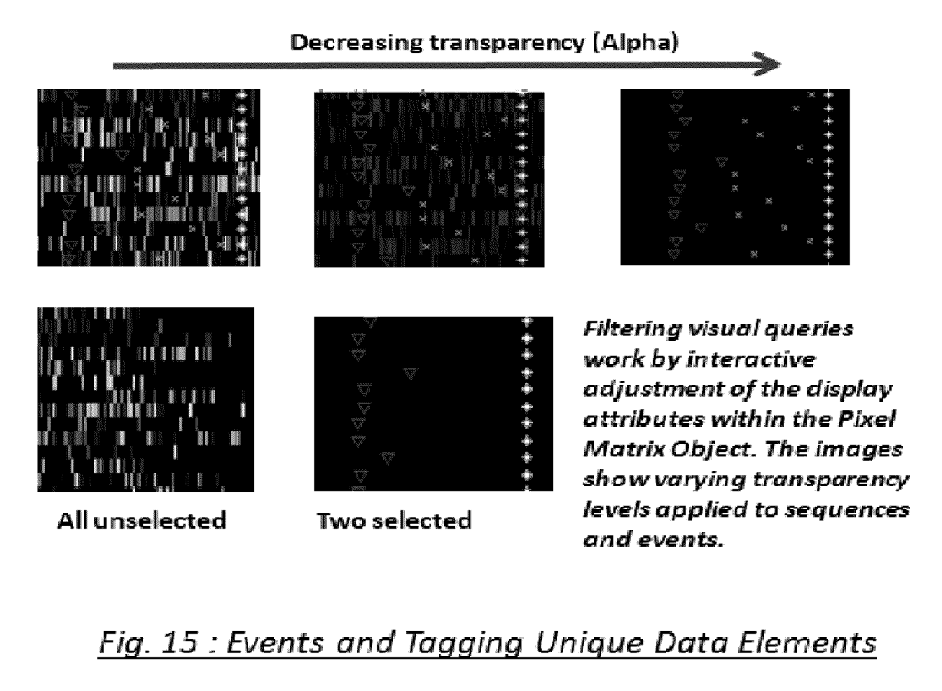

FIGS. 14 and 15 show the results of performing a visual filtering query with the present invention. Visual filtering queries 514 provide for the selective visual display of data. This type of query is useful in suppressing visual clutter. The slider controls of 514 control display attributes such as transparency Alpha 824 and ColorMapLUT 820 of a selected Queryable Pixel Matrix 820. FIG. 14 shows the effect of visual filtering data display in the previous usage example. FIG. 15 shows another example of selective adjustment of visual attributes in order to selectively view relationships between events and sequential data.

### Usage Example 3

### Predictive Modeling with Events

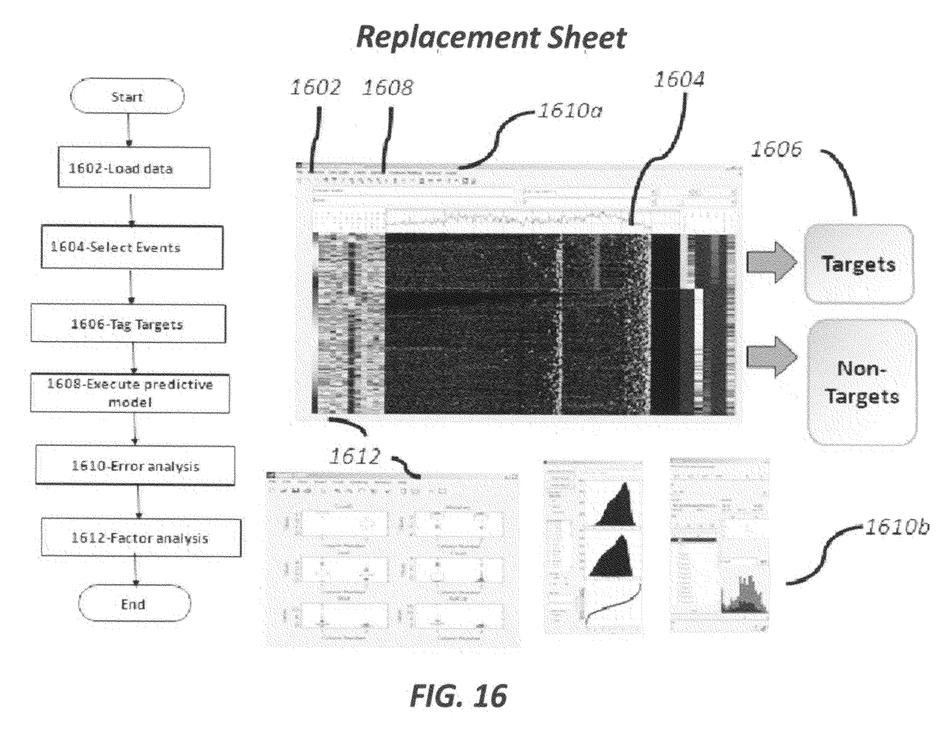

FIG. 16 illustrates the steps involved in predictive modeling with the present invention. First, data is loaded via the drop-down menu 1602. Events are selected as a distinct group 1604. The examples are tagged as ‘targets’ and non-targets 1606. A Logistic regression is selected as the predictive model 1608. The predictive model uses the data in the Explanatory Data Matrix as regressors. Next, error analysis is performed by querying predicted versus actual outcomes (true positive, true negative, false positive, false negative) 1610a and performance error curse 1610b. Perform factor analysis by inspecting box plots of regressors 1612, via drop down menu on front panel.

### APPLICATIONS

The present invention is well-suited for interactive visualization and analysis of data from many different types of databases and sources of data. Just a few of the possible uses of the invention are the visualization and analysis of financial data, marketing data, experimental data, data from sensor networks, data from manufacturing processes, internet commerce transactions, internet and computer network activity analysis, network intrusion analysis and detection, gaming and casino analytics, fraud detection, telecommunications data, electrical power distribution, advanced metering data quality, reconciling and clearing of financial transactions.

In one preferred embodiment, the present invention is applied to customer analytics or the analysis of customer behavior. In broad terms, the objective of customer analytics is to optimize the profitability of customer outreach such as promotional offers.

The present invention may be used to perform computer network analysis, including click fraud detection, click detection, intrusion detection, ad-server optimization, network latency analysis, bot-net and malware analysis and diagnostics.

In another preferred embodiment, the present invention may be applied to the statistical analysis of sensor networks. Example sensors include but are not limited to: temperature sensors, pressure sensors, acceleration sensors, electrical current sensors and voltage sensors. Networks of sensors are found in laboratory, manufacturing and component testing environments.

In another preferred embodiment, the present invention may be used in financial services and financial market analysis. In these settings, financial transactions are recorded electronically and are stored for analysis in a data warehouse. The present invention may be used to analyze and reconcile the accounting of financial transactions in back-office operations. Alternatively, financial data may be analyzed in real-time in order to identify market trends early in their formation.

In yet another preferred embodiment, the present invention may be used to detect criminal activity such as money laundering, fraud, unauthorized access to computer accounts.

In yet another preferred embodiment, the present invention may be used to analyze data quality. In this embodiment, the present invention enables analysts to identify patterns that may be symptomatic of systemic failures in data acquisition and processing.

In yet another preferred embodiment, the present invention may be used in the failure-mode analysis of electrical and electro-mechanical systems. In this embodiment, the present invention enables analysts to visualize and quantify patterns leading to component or system failure. In this embodiment, a wide range of sensors may be used in order to acquire data related to the health and condition of the system. These devices include but are not limited to accelerometers, vibration sensors, temperature and pressure sensing devices.

In yet another preferred embodiment, the present invention may used as a front-end or presentation-layer to a data-mining platform. In this embodiment, the analyst may label data examples, perform statistical analysis and view classification and regression results via the visual interface provided by the invention.

In yet another preferred embodiment, the present invention may be used for the exploratory analysis of biological nucleic acid sequences. In this embodiment, the analyst may be searching for patterns in sequences of genetic expression that co-occur with known responses to environmental stress factors.

In yet another preferred embodiment, the present invention may be used to monitor and evaluate the effectiveness of advertising campaigns conducted via social media and SMS messages.

The present invention may be used with interactively with spatial renderings of data, including geographical maps and maps of commercial enterprises such as retail floors, showrooms and casinos.

The present invention may also be used interactively with other forms of data visualization such as link maps, link-graphs heat-maps, stock tickers and tree-maps, spectrograms, line graphs, scatter-plots, histograms, bubble charts, edge maps, motion bubble charts.

In yet another preferred embodiment, the present invention may be used as a front-end query system or presentation layer to a data warehouse or data repository. In this embodiment, the visual interface enables the analysts to enter database queries in via the graphical interface of the present invention. In this embodiment, the present invention translates user-directed commands from the graphical interface into statements in a standard query language such as SQL. In a similar embodiment, the present invention may be used as a front-end query system or presentation layer to a specialized analytical database or data warehouse that implements columnar data structures or HADOOP or massively parallel data access.

### CONCLUSION, RAMIFICATIONS AND ADVANTAGES OF THE PRESENT INVENTION

The present invention has a number of distinct advantages over current methods of interacting and querying data. The analyst works with greater efficiency and accuracy because queries are posed and results are viewed on granular visual renderings of data. The ability to query, view and interact with data on a granular level makes it possible to more rapidly discern patterns, correlations and anomalies that may be infrequent but are of economically significance or possess predictive value.

The advantages of the present invention include methods by which analysts may interact more productively with granular data. These capabilities are made possible by combining granular views of data with user interactions in a manner that leverages the innate capacity of the human visual system to rapidly discern patterns, correlations and anomalies in visual imagery. The methods described within the present invention describe how data may mapped to a visual representation that accesses this powerful capability of the human visual system.

The present invention also accelerates the process of statistical analysis of grouped data that is typically encountered in statistical population studies. Statistical population studies involve the comparison of grouped data that is more accurately viewed and manipulated in granular form as described by the methods disclosed within the present invention.

The present invention also accelerates the process of building predictive models. The construction of predictive models involve the analysis of interactions between model components such as explanatory metrics, performance metrics, outcomes and group population labels as described in the present invention. The accuracy and the effectiveness of predictive models is limited by the ability of the analyst to view and manipulate data in a granular form and to query for granular relationships between model components. The methods described within the present invention enable the analyst to manipulate and view granular data in the process of building predictive models.

In broad terms in one form the present invention comprises a system for interactive querying and quantitative analysis of data on a computer display. Data is visually represented on a computer display as a plurality of queryable pixel-matrices comprising color-coded pixel-elements. Queryable pixel-matrices may be interconnected in a manner that reveals relationships across differing views of the data. The present invention also provides for statistical analysis via renderings of the data that are displayed as query-able pixel-matrices.

The present invention provides for greater freedom related to the analytical trade-off between granularity and volume of data. The invention provides for the interactive display of maximum density of data to be visualized on a computer display through the data rendering methods described herein.

The invention provides for immediate feedback of data queries as the user interacts directly with renderings of the data. Using the methods described within this invention, the display screen is updated with query results in a period of time that is unnoticeable to the analyst. This aspect of the invention is supported by the methods related to pixel operations as described herein.

The present invention provides for instantaneous suppression of visual clutter by user-selected display of data attributes such as pixel transparency. This enables the analyst to more efficiently focus on relevant aspects of the data query.

This present invention accelerates the process of statistical modeling by enabling direct interaction with data to perform data-mining activities. These include, but are not limited class labeling class-dependent statistical analysis such as hypothesis testing and predictive modeling.

Yet another aspect of the invention is the ability to perform predictive analytics and statistical analysis directly on query-able pixel matrices. This aspect of the invention accelerates the iterative process of analytic discovery by providing immediate visual feedback on the performance of the analytic model.

What is claimed is:

1. A method of interactive querying of data comprising:
Displaying the data in a queryable pixel matrix;
Receiving a user query on the queryable pixel matrix;
And rearranging the queryable pixel matrix based on user interaction.
